(19) United States
(12) Patent Application Publication
(10) Pub. No.: US 2011/0121157 A1
(43) Pub. Date: May 26, 2011

(54) STRUCTURE FOR PREVENTING SEPARATION OF INSULATOR IN TM MOUNT

(75) Inventor: YONG-BIN PARK, Bucheon-shi (KR)

(73) Assignee: Kia Motors Corporation, Seoul (KR)

(21) Appl. No.: 12/784,974

(22) Filed: May 21, 2010

(30) Foreign Application Priority Data
Nov. 23, 2009 (KR) 10-2009-0113339

(51) Int. Cl. F16M 13/02

(52) U.S. Cl. 248/674

(57) ABSTRACT

A mount apparatus of a vehicle having a structure for preventing separation of an insulator with a bracket, may include the bracket formed in a cylindrical pipe and covered with a rib at a side thereof, wherein the rib includes a hole, and the insulator coupled into the bracket, including, an inner core disposed in the bracket and an end portion thereof extending outside the hole of the rib, a first protrusion and a second protrusion formed to the inner core and extending toward the forward and rearward directions of the vehicle respectively in the bracket to prevent the insulator from separating from the bracket, wherein the first protrusion further protrudes than the second protrusion, and an insulating portion formed around the inner core.

The present application claims priority to Korean Patent Application No. 10-2009-0113339, filed on Nov. 23, 2009, the entire contents of which is incorporated herein for all purposes by this reference.

### BACKGROUND OF THE INVENTION

1. Field of the Invention

The present invention relates to a structure for preventing separation of an insulator in a TM (“transmission”) mount, in more detail, a structure for preventing separation of an insulator in a TM mount to improve NVH (“noise, vibration, and harshness”) performance of a vehicle.

2. Description of Related Art

In general, a TM mount is a device connecting a power train with a car body, which supports the load and controls displacement of the power train, and prevents vibration and noise of the power train from being transmitted to the car body.

Since a power train weighing hundreds of kilograms is usually supported by three to four mounts, each mount requires high durability and endurance against a collision. In particular, even if the power trains is pushed backward in a head-on collision of vehicles, the bracket or the insulator in the mount should be able to support the power train under this large load, without breaking. This is because the dash panel and the pedals are deformed by the power train pushed backward and may cause serious damage to the passenger's knees and ankles.

FIG. 1A is a view showing the structure of a TM mount of the related art and FIG. 1B is a cross-sectional view showing an insulator that is press-fitted in the TM mount of the related art.

As shown in the figures, an insulator is press-fitted in a bracket 11 connected to the car body and an inner core 13 disposed at the center portion of the insulator is connected to a TM mount. In a head-on collision, bridges 12 of the insulator are broken and the inner core 13 connected to the TM mount is separated. Therefore, a retainer for the TM mount is removed, such that the amount of pushed-back of the power train increases and collision performance is reduced.

Addressing this problem, a TM mount having the following structure has been proposed. FIG. 2 is a view illustrating an embodiment of a separation prevention structure for a TM mount of the related art, in which an individual separation prevention bracket 21 is provided and it is locked to a TM mount bracket 22 such that the insulator is not separated in a collision. This structure has a problem that it has a limit in space due to the individual bracket and the cost and weight excessively increase, such that it is difficult to be widely used.

Addressing this problem, a TM mount having the following structure has been proposed. FIG. 3 is a cross-sectional view of an insulator, illustrating a separation prevention structure of a TM mount of the related art, in which the shape of a bracket changed to be blocked in the separable direction.

As shown in the figures, the separation prevention structures of the related art were implemented by forming the protrusion 34 on the inner core inside the insulator and changing the shape of the bracket 31 to be blocked in the separable direction. Even in this structure, however, the insulator is separated in a collision and insulation performance of vibration/noise is reduced by a protrusion 34 of an inner core 33, thereby reducing NVH performance.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a structure for preventing separation of an insulator in a TM mount to prevent the insulator in the TM mount from separating.

Further, various aspects of the present invention are directed to provide a structure for preventing separation of an insulator in a TM mount to improve NVH performance of a vehicle.

According to an aspect of the present invention, the mount apparatus of a vehicle having a structure for preventing separation of an insulator with a bracket, may include the bracket formed in a cylindrical pipe and covered with a rib at a side thereof, wherein the rib includes a hole, and the insulator coupled into the bracket, may have an inner core disposed in the bracket and an end portion thereof extending outside the hole of the rib, a first protrusion and a second protrusion formed to the inner core and extending toward the forward and rearward directions of the vehicle respectively in the bracket to prevent the insulator from separating from the bracket, wherein the first protrusion further protrudes than the second protrusion, and an insulating portion formed around the inner core.

The insulating portion may be formed around the inner core, the first protrusion and the second protrusion.

The mount apparatus may further include a stopper formed along the inner circumference of the bracket except for where the first protrusion and the second protrusion are formed between the inner core of the insulator and the bracket.

A center axis of the hole and a center axis of the inner core may be offset with a predetermined distance, wherein the center axis of the hole is offset from the center axis of the inner core with the predetermined distance in a rearward direction of the vehicle, and wherein the center axis of the inner core are aligned substantially along a center axis of the bracket.

The hole may be in an oval shape extending in one direction.

According to the present invention having the above configuration, it is possible to prevent separation of the insulator in a collision, by making the front protrusion further protrude than the rear protrusion and shifting the hole of the pipe bracket to the rearward of a vehicle.

Further, according to the present invention, it is possible to improve NVH performance by forming stopper over the protrusions of the inner core.

Therefore, it is possible to decreases damage to the passenger's knees and ankles, by preventing separation of the insulator in a collision to reduce the amount of backward-pushing of the power train.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1A is a view showing the structure of a TM mount of the related art.

FIG. 1B is a cross-sectional view of an insulator that is press-fitted in the TM mount of the related art.

FIG. 2 is a view illustrating an example of a separation prevention structure of a TM mount of the related art.

FIG. 3 is a cross-sectional view of an insulator, illustrating a separation prevention structure of a TM mount of the related art.

FIG. 4 is a view illustrating the configuration of an exemplary TM mount according to the present invention.

FIG. 5 is an exploded perspective view of the TM mount shown in FIG. 4.

FIGS. 6A and 6B are schematic view illustrating an asymmetric inner core according to a related art and an exemplary embodiment of the present invention respectively.

FIGS. 7A and 7B are schematic views illustrating holes of a pipe bracket according to a related art and an exemplary embodiment of the present invention respectively.

FIGS. 8A and 8B are schematic views illustrating a stopper according to a related art and an exemplary embodiment of the present invention respectively.

FIG. 9 is a cross-sectional view of an exemplary TM mount of the present invention.

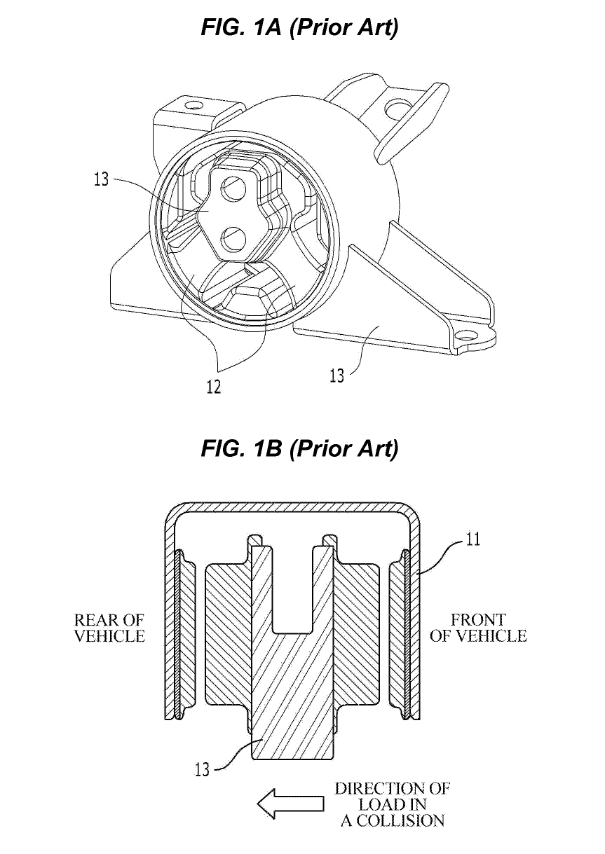

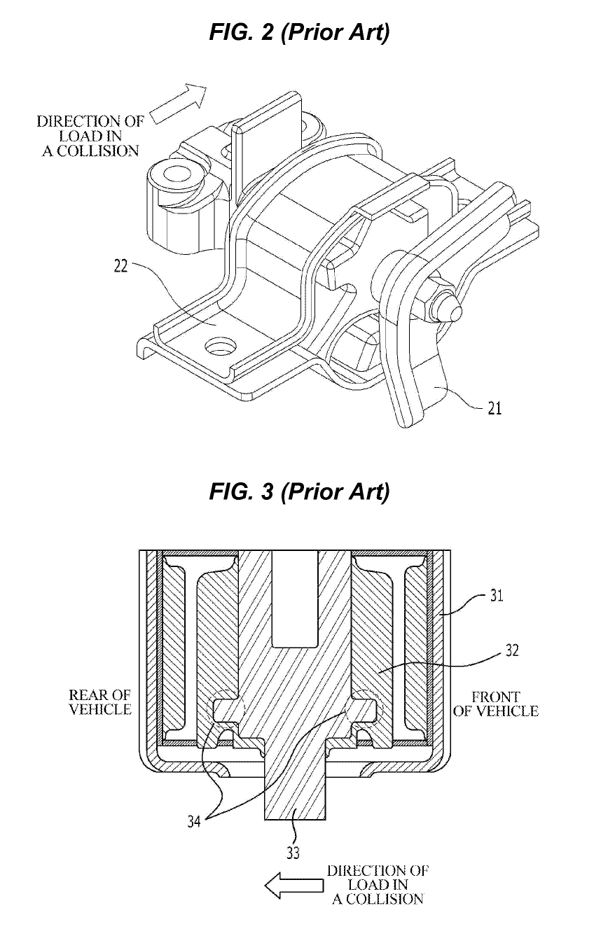

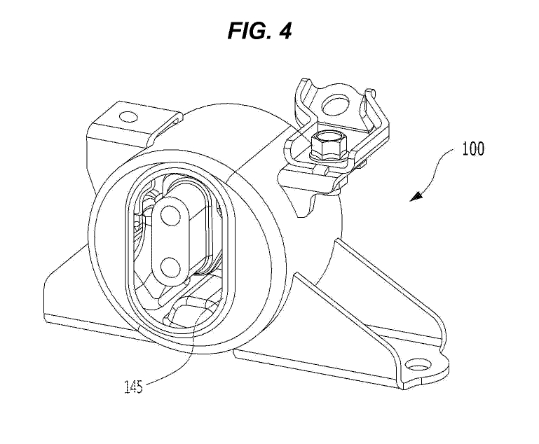

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention are described hereafter in detail with reference to the accompanying drawings.

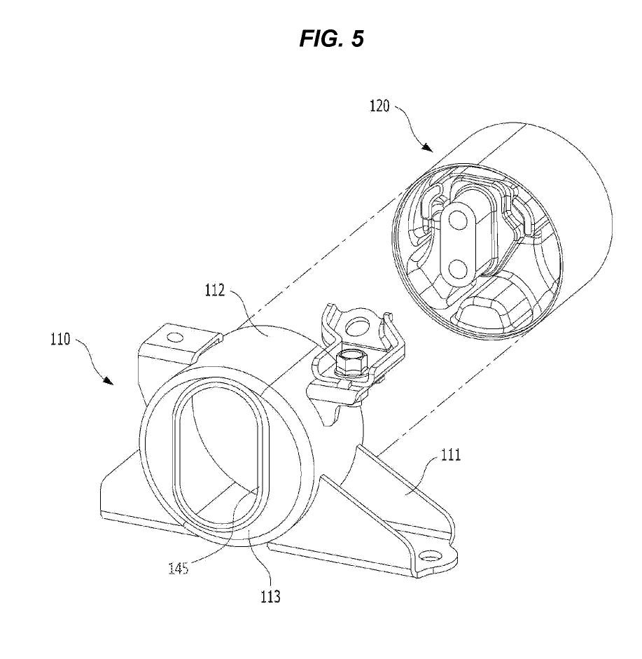

FIG. 4 is a view illustrating the configuration of a TM mount 100 according to an exemplary embodiment of the present invention and FIG. 5 is an exploded perspective view of the TM mount shown in FIG. 4. The TM mount 100 according to an exemplary embodiment of the present invention is formed by press-fitting an insulator 120 in a bracket 110. As shown in the figures, the bracket 110 is formed of a cylindrical pipe bracket 112 with lugs 111, the pipe bracket 112 has a rib 113 at one side to prevent the insulator 120 from separating in a collision, and a predetermined shaped hole 145 is formed in the rib 113. It is preferable that the hole 145 has an oval shape extending in one direction. The insulator 120 is described below in detail with other figures.

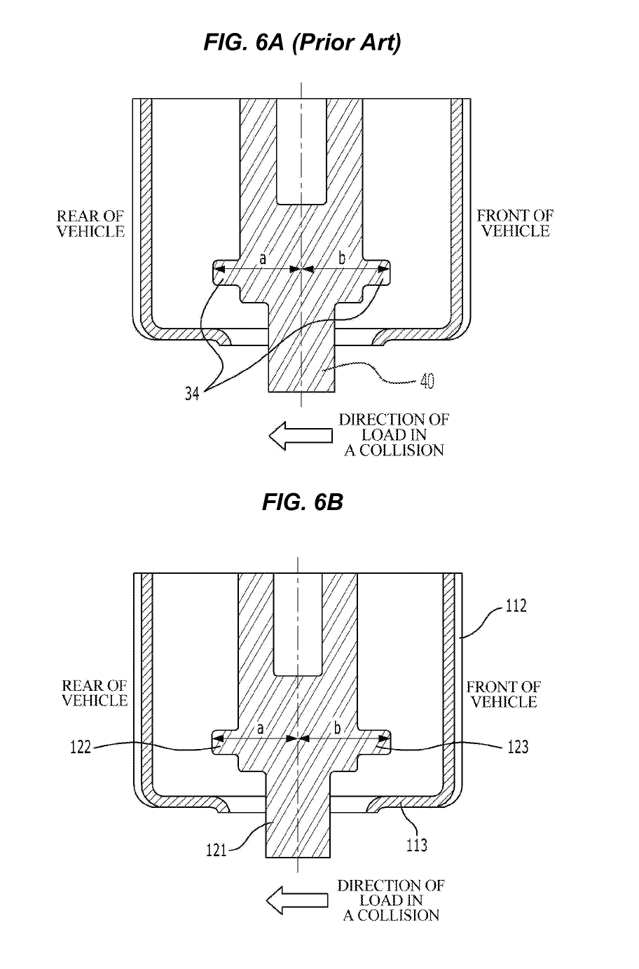

A TM mount according to an exemplary embodiment of the present invention has an asymmetric inner core, an asymmetric pipe bracket shifted toward the rear of a vehicle, and an optimized stopper. FIGS. 6B, 7A and 7B, and 8A and 8B are schematic view illustrating a TM mount according to an exemplary embodiment of the present invention.

FIGS. 6A and 6B are schematic view illustrating an inner core, in which FIG. 6A is for illustrating a symmetric inner core of the related art and FIG. 6B is for illustrating an asymmetric inner core according to an exemplary embodiment of the present invention.

Referring to FIG. 6A, a protrusion 34 of an inner core 40 in the related art is a part formed inside the TM mount for separation prevention, such that it has the advantage of capable of using the TM mount without being limited in space, as compared with the structure having a specific separation prevention bracket (described with reference to FIG. 2). However, the amount of insulating portion 32 of the insulator is reduced by the protrusion 34, such that NVH performance is reduced, including reduction of insulation performance of vibration and deterioration of traveling booming. In other words, the protrusion should be large for the collision performance, and small for NVH performance.

The present invention proposes the structure shown in FIG. 6B to satisfies all of the opposite requirements. As shown in the figure, an inner core 121 according to an exemplary embodiment of the present invention has an asymmetric structure with a large protrusion 123 at the front of a vehicle (referred to as a ‘front protrusion’) and a small protrusion 122 at the rear of the vehicle (referred to as a ‘rear protrusion’). That is, assuming the distance from the center of the inner core 121 to the rear protrusion 122 is a and the distance from the center of the inner core 121 to the front protrusion 123 is b, ‘a=b’ in the related art, but ‘a<b’ in the present exemplary embodiment of the present invention.

According to the present exemplary embodiment of the present invention, since the power trains is pushed backward and separated in a collision, it is possible to secure separation prevention by forming the front protrusion 123 as large as possible and to reduce vibration and noise when the vehicle travels at the D-stage by forming the rear protrusion 122 influencing NVH of the vehicle traveling at the D-stage as small as possible.

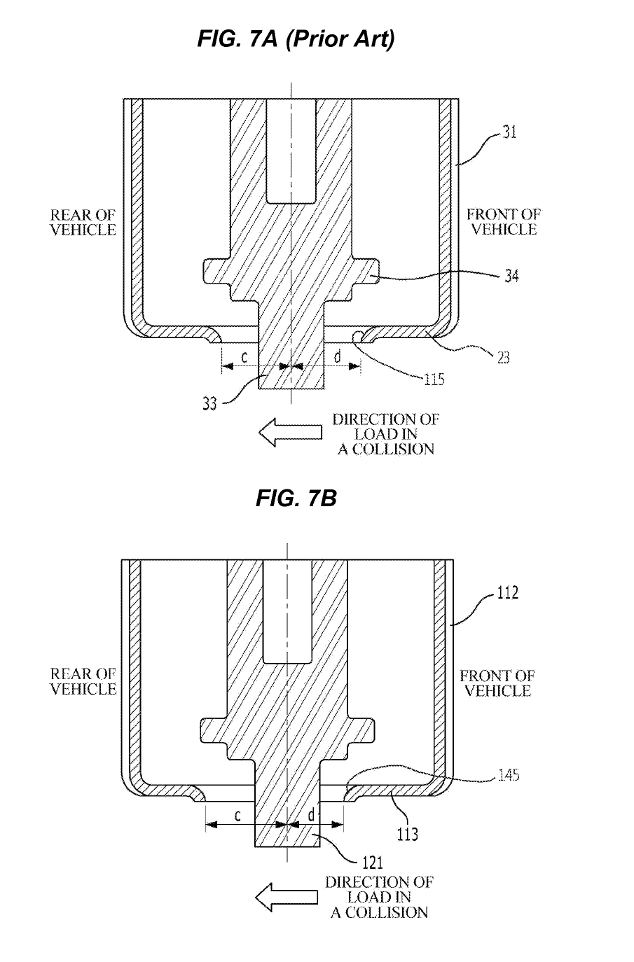

FIGS. 7A and 7B are schematic views illustrating holes of a pipe bracket, in which FIG. 7A is for illustrating a hole 115 of the related art and FIG. 7B is for illustrating a hole 145 according to an exemplary embodiment of the present invention.

Since the power train is pushed backward in a head-on collision of a vehicle, the insulator in the TM mount connected with the power train is pushed backward and separated. As shown in FIG. 7A, a hole 115 formed by a rib 23 of a pipe bracket 31 is positioned at the center, such that the front protrusion of a protrusion 34 of an inner core 33 cannot prevent separation when the power train is pushed backward. Therefore, the insulator is easily separated.

However, according to an exemplary embodiment of the present invention, a hole 145 is shifted backward from the center in consideration of the backward-pushing in a collision, as shown in FIG. 7B, such that it is possible to effectively prevent separation in a collision. That is, assuming that the distance from the center of an inner core 121 to the hole 145 at the rear side of the vehicle is c and the distance from the center of an inner core 121 to the hole at the front side of the vehicle is d, ‘c=d’ in the related art, but ‘c>d’ in the present exemplary embodiment of the present invention.

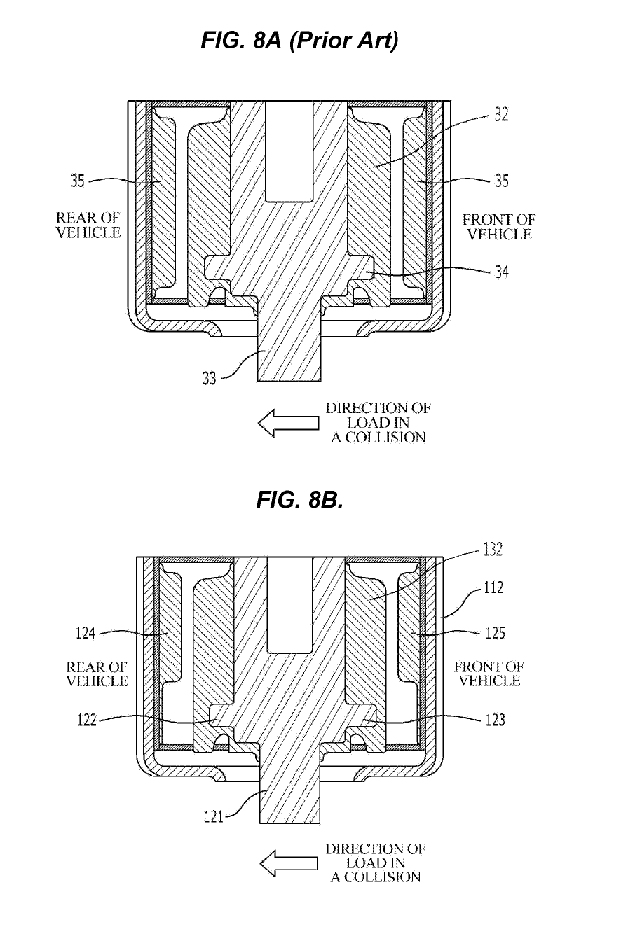

FIGS. 8A and 8B are schematic views illustrating a stopper, in which FIG. 8A is for illustrating a stopper of the related art and FIG. 8B is for illustrating a stopper according to an exemplary embodiment of the present invention.

As shown in FIG. 8A, there is a problem in an insulator of the related art that the gap between an inner core 33 and a stopper 35 at the front and rear of a vehicle is decreased by a protrusion 34 of the inner core 33. This has an adverse influence on NVH performance in traveling at the D-stage or R-stage. Therefore, the present invention proposes a structure having stoppers, except for the front-rear direction of a protrusion of an inner core.

As shown in FIG. 8B, stoppers 124 and 125 according to an exemplary embodiment of the present invention are formed around the insulating portion 132 of the inner core 121 beyond a front protrusion 123 and a rear protrusion 122 of an inner core 121. The stoppers 124 and 125 are formed in a cylindrical shape along the inner circumference of a pipe bracket 112, and they are designated by difference reference numerals, but are connected.

With this structure, it is possible to improve NVH performance in traveling at the D-state or R-stage, by generating stopping by the insulating portion 132 while the front and rear protrusions 123 and 122 of an inner core 121 do not contact with the bracket 112.

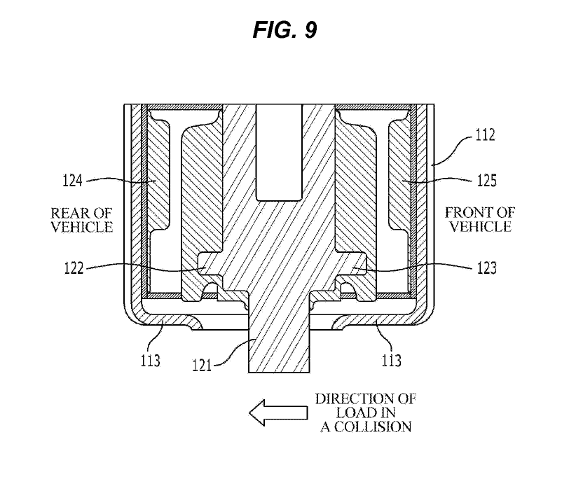

FIG. 9 is a cross-sectional view showing a TM mount according to an exemplary embodiment of the present invention, which implements all of the characteristics shown in FIGS. 6B, 7B and 8B.

As shown in the figure, according to the structure of a mount of the present exemplary embodiment, the front protrusion 123 further protrudes than the rear protrusion 122 in an inner core 121, such that it is possible to prevent separation of the inner core 121 in a collision and reduce vibration and noise of the vehicle in traveling at the D-stage.

Further, a hole 145 (see FIG. 4 or 5) that extends in one direction of a pipe bracket 112 is shifted toward the rear of the vehicle to be asymmetric, such that it is possible to prevent the inner core 121 from separating in a collision.

Further, in the TM mount according to the present exemplary embodiment of the present invention, a front stopper 125 and a rear stopper 124 are formed beyond the protrusions 123 and 122 of the inner core 121, that is, the stoppers 125 and 124 are formed only at the portion without the protrusions 123 and 122, such that it is possible to improve NVH performance in traveling at the D-stage or R-stage.

For convenience in explanation and accurate definition in the appended claims, the terms “upper”, “lower” “front” and “rear” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A mount apparatus of a vehicle having a structure for preventing separation of an insulator with a bracket, comprising:
the bracket formed in a cylindrical pipe and covered with a rib at a side thereof, wherein the rib includes a hole; and
the insulator coupled into the bracket, including:
an inner core disposed in the bracket and an end portion thereof extending outside the hole of the rib;
a first protrusion and a second protrusion formed to the inner core and extending toward the forward and rearward directions of the vehicle respectively in the bracket to prevent the insulator from separating from the bracket, wherein the first protrusion further protrudes than the second protrusion; and
an insulating portion formed around the inner core.

2. The mount apparatus according to claim 1, wherein the insulating portion is formed around the inner core, the first protrusion and the second protrusion.

3. The mount apparatus according to claim 1, further comprising:
a stopper formed along the inner circumference of the bracket except for where the first protrusion and the second protrusion are formed between the inner core of the insulator and the bracket.

4. The mount apparatus according to claim 1, wherein a center axis of the hole and a center axis of the inner core are offset with a predetermined distance.

5. The mount apparatus according to claim 4, wherein the center axis of the hole is offset from the center axis of the inner core with the predetermined distance in a rearward direction of the vehicle.

6. The mount apparatus according to claim 5, wherein the center axis of the inner core are aligned substantially along a center axis of the bracket.

7. The mount apparatus according to claim 1, wherein the hole is in an oval shape extending in one direction.

8. A mount apparatus of a vehicle having a structure for preventing separation of an insulator from a bracket, the insulator being press-fitted in the bracket,
wherein the bracket is formed in a cylindrical pipe and includes a rib at a side thereof and receives the insulator therein, and
wherein a predetermined shaped hole is formed in the rib, and the hole is in an oval shape extending in one direction and shifted rearward from a center axis of the bracket.
